(19) United States
(12) Patent Application Publication
(10) Pub. No.: US 2010/0001937 A1
(43) Pub. Date: Jan. 7, 2010

(54) System and Method for Driving a Display Panel

(76) Inventor: Cheng-Chi Yen, Tainan (TW)

Correspondence Address: STOUT, UXA, BUYAN & MULLINS LLP, 4 VENTURE, SUITE 300, IRVINE, CA, 92618, US

(21) Appl. No.: 12/400,700

(22) Filed: Mar. 9, 2009

Related U.S. Application Data
(63) Continuation-in-part of application No. 12/168,067, filed on Jul. 4, 2008.

(51) Int. Cl. G09G 3/36; G09G 3/20

(52) U.S. Cl. 345/87; 345/55

(57) ABSTRACT

A multi-branch pixel structure of a display panel, such as a liquid crystal on silicon (LCoS) panel, is disclosed. Each pixel cell of the display panel has at least two branches. For each column, two sub-data lines are coupled from a data driver. A multiplexer is configured to multiplex the sub-data lines between the adjacent pixel cells, such that multiplexed output of the multiplexer is coupled to a shared data line that is shared between the adjacent pixel cells, thereby substantially decreasing the pixel pitch.

### CROSS-REFERENCE TO RELATED APPLICATIONS

The present invention is a continuation-in-part (CIP) of U.S. application Ser. No. 12/168,067, filed Jul. 4, 2008 and entitled “Display Panel and Multi-Branch Pixel Structure Thereof,” the entire contents of which are incorporated herein by reference.

### BACKGROUND OF THE INVENTION

1. Field of the Invention

The present invention generally relates to a display panel, and more particularly to a system and method of driving a liquid crystal on silicon (LCoS) panel with multi-branch pixel structure.

2. Description of the Prior Art

Liquid crystal on silicon (LCoS or LCOS) is a reflective technology that can produce a higher resolution image, at a lower cost, than liquid crystal display (LCD) technology, and has been developed as the optical engine for micro-projection or micro-display systems. Similar to the structure of an LCD, the LCoS typically includes rows and columns of picture elements (or pixels) arranged in matrix form. Each pixel unit cell 10 (as shown in FIG. 1) includes a transistor QA, which is addressed by a scan signal (Scan) on a scan line 12 (or gate line). The pixel unit cell 10 also includes a storage capacitor C, which is designed to receive and store image data (Data) provided by a data line 14 (or source line) via the transistor QA. The gates of transistors QA in the same row are connected together through the scan line 12, and controlled by a scan driver or gate driver (not shown). The sources of transistors QA in the same column are connected together through the data line 14 and controlled by a data driver or source driver (not shown). In operation, the transistor QA is firstly addressed by the scan signal (Scan), such that the transistor QA is turned on and the image data can be stored in the storage capacitor C. Subsequently, the charge in the storage capacitor C is transferred and displayed.

Operating speed is one of the issues to be improved upon the LCoS or other display system, for the reason that liquid crystal needs time to respond to the image data. This issue demands more stringent attention when the LCoS resolution increases. For the foregoing reason, a need has arisen to propose a novel structure to substantially increase LCoS operating speed. With respect to another issue to be improved upon the LCoS or other display system, a high-capacity pixel cell is needed to arrive at a compact LCoS.

### SUMMARY OF THE INVENTION

In view of the foregoing, it is an object of the present invention to provide a novel system and method of driving a multi-branch flat panel display, such as an LCoS display, for substantially increasing operating speed and reducing coupling effect.

It is another object of the present invention to provide a novel multi-branch pixel structure with reduced pixel pitch and chip area.

According to one embodiment of the present invention, a multi-branch pixel structure of a display panel, such as an LCoS display, has a number of pixel cells arranged in matrix form, each pixel cell having at least two branches. The two branches enter an addressing mode and a displaying mode in turn. The display panel has a pair of sub-data lines for each column of the pixel cells, and the sub-data lines are controllably coupled to the two branches respectively. In operation, the first branch is addressed, in a frame, such that image data provided on the first sub-data line is transferred and stored in the first branch, while the stored image data of the second branch is displayed. Subsequently, the second branch is addressed, in a neighboring frame, such that image data provided on the second sub-data line is transferred and stored in the second branch, while the stored image data of the first branch is displayed.

According to another embodiment of the present invention, each pixel cell of the display panel has at least two branches. For each column, two sub-data lines are coupled from a data driver, where the two sub-data lines respectively correspond to the two branches. A multiplexer is configured to multiplex the sub-data lines between the adjacent pixel cells, such that the multiplexed output of the multiplexer is coupled to a shared data line that is shared between the adjacent pixel cells, thereby substantially decreasing the pixel pitch. In operation, the two sub-data lines are multiplexed, such that the multiplexed output is coupled to a shared data line shared between adjacent pixel cells. In the addressing mode, the branch corresponding to the multiplexed sub-data line is addressed, such that image data on the multiplexed sub-data line is stored in the addressed branch. In the displaying mode, the stored image data is then displayed.

### BRIEF DESCRIPTION OF THE DRAWINGS

FIG. 1 illustrates a pixel unit cell of a conventional LCoS;

FIG. 2A illustrates a multi-branch pixel structure of the invention;

FIG. 2B illustrates a pixel unit cell of the multi-branch pixel structure of FIG. 2A;

FIG. 3A and FIG. 3B illustrate the operation of the pixel unit cell of FIG. 2B;

FIG. 4 shows an exemplary timing diagram illustrating the operation associated with FIG. 3A and FIG. 3B;

FIG. 5 shows the LCoS operation similar to that illustrated in FIG. 3A, with unwanted parasitic capacitance Cds of the addressing transistor QA_{B} having been taken into consideration;

FIG. 6A illustrates a multi-branch pixel structure according to one embodiment of the present invention;

FIG. 6B illustrates a pixel unit cell of the multi-branch pixel structure of FIG. 6A;

FIG. 7A and FIG. 7B illustrate the operation of the pixel unit cell of FIG. 6B;

FIG. 8 shows an exemplary timing diagram illustrating the operation associated with FIG. 7A and FIG. 7B;

FIG. 9 illustrates one pixel unit cell of a multi-branch pixel structure;

FIG. 10A illustrates a multi-branch pixel structure of the LCoS panel according to another embodiment of the present invention;

FIG. 10B illustrates detailed circuitry of portions of the multi-branch pixel structure in FIG. 10A;

FIG. 10C shows that adjacent pixel cells share their source/drain; and

FIG. 11A through FIG. 11D illustrate the operation of the multi-branch pixel structure of the LCoS panel of FIG. 10A and FIG. 10B.

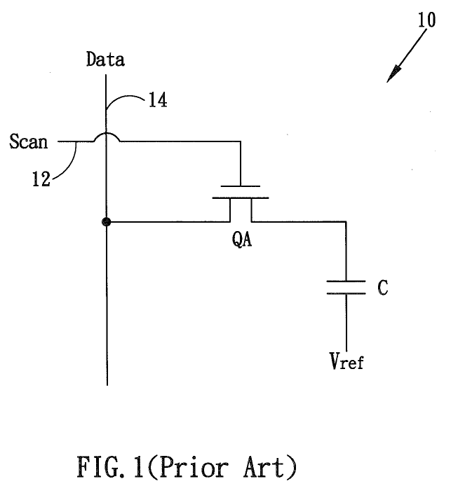

### DETAILED DESCRIPTION OF THE INVENTION

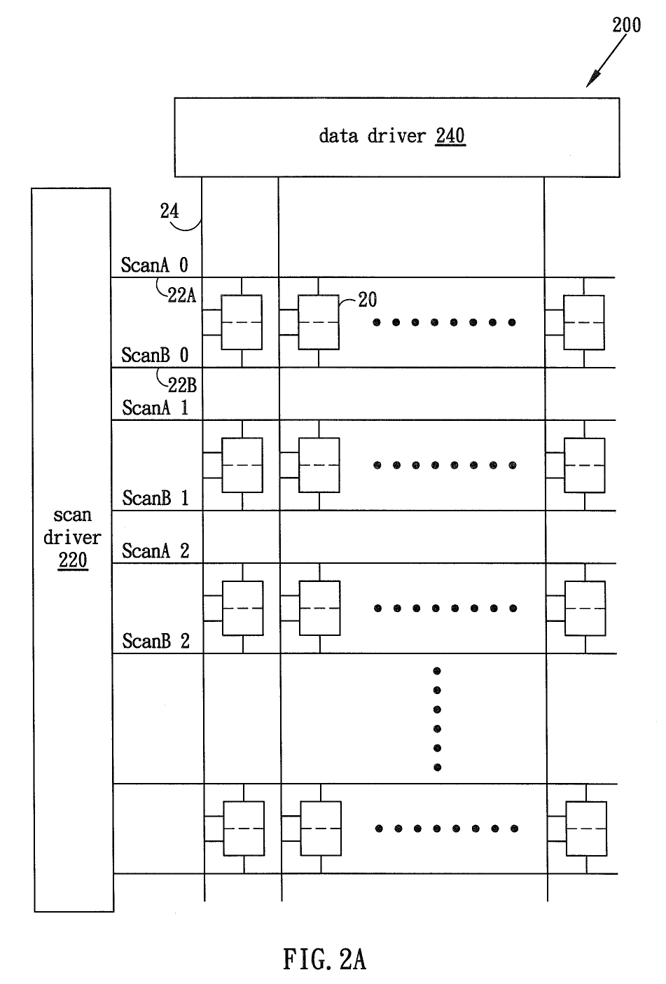

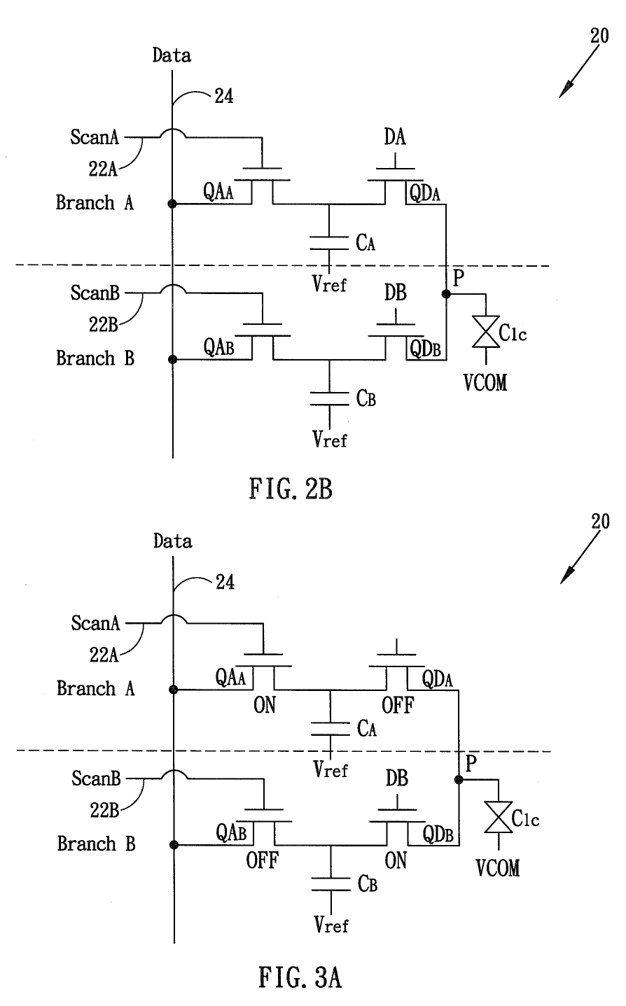

FIG. 2A illustrates a multi-branch pixel structure of the liquid crystal on silicon (LCoS or LCOS) panel 200, and FIG. 2B illustrates one of the pixel unit cells 20 of the multi-branch pixel structure in FIG. 2A. Although the LCoS layout is illustrated here, it is appreciated by those skilled in the pertinent art that the illustrated structure can be well adapted to other reflective/transmissive flat panel displays, such as liquid crystal displays (LCDs). Referring to FIG. 2A, the LCoS panel 200 includes rows and columns of picture elements (or pixels) or pixel cells 20 arranged in matrix form. Pixel cells 20 in the same row are under control of scan signals (ScanA n and ScanB n, n=0, 1, 2, etc.) on the scan lines (or gate lines) 22A and 22B; while pixel cells 20 in the same column are electrically coupled to a data line (or source line) 24. The scan lines 22A and 22B are controlled by a scan (or gate) driver 220, and the data lines 24 are controlled by a data (or source) driver 240.

Referring to FIG. 2B, the pixel unit cell 20 includes at least two branches, that is, Branch A and Branch B. Taking Branch A as an example, it includes an addressing transistor QA_{A}, such as a metal-oxide-semiconductor (MOS) transistor, which is configured to be addressed, for example, via the gate of the addressing transistor QA_{A}, by a scan signal (ScanA) on the scan line 22A. Specifically, one end, such as the source, of the channel of the addressing transistor QA_{A} is electrically coupled to the data line 24.

Branch A also includes a storage capacitor C_{A}, which is configured to receive image data on the data line 24 via the addressing transistor QA_{A}. Specifically, one end of the storage capacitor C_{A} is electrically coupled to the other end, such as the drain, of the channel of the addressing transistor QA_{A}. The other end of the storage capacitor C_{A} is electrically coupled to a reference voltage Vref or the ground.

Branch A further includes a displaying transistor QD_{A}, such as an MOS transistor, through which the stored image data in the storage capacitor C_{A} is displayed. The displaying transistor QD_{A} is configured to buffer the stored image data until the startup of the display. Specifically, the gate of the displaying transistor QD_{A} is controlled by a control signal DA. One end, such as the source, of the channel of the displaying transistor QD_{A} is electrically coupled to the drain of the addressing transistor QA_{A}, and coupled to one end of the storage capacitor C_{A}. Another end, such as the drain, of the channel of the displaying transistor QD_{A} is electrically coupled to a pixel electrode P. A liquid crystal capacitor C_{1c} equivalently represents a liquid crystal capacitance connected between the pixel electrode P and a common electrode. The common electrode provided at the display panel is arranged to face the pixel electrode P in an opposed manner, and coupled to a common voltage VCOM. The stored image data applies to the corresponding pixel electrode P and alters the transparency or reflectivity of the liquid crystal overlies thereon. The description for Branch A applies to the addressing transistor QA_{B}, the storage capacitor C_{B}, the displaying transistor QD_{B}, the scan signal (ScanB), and the control signal DB in Branch B.

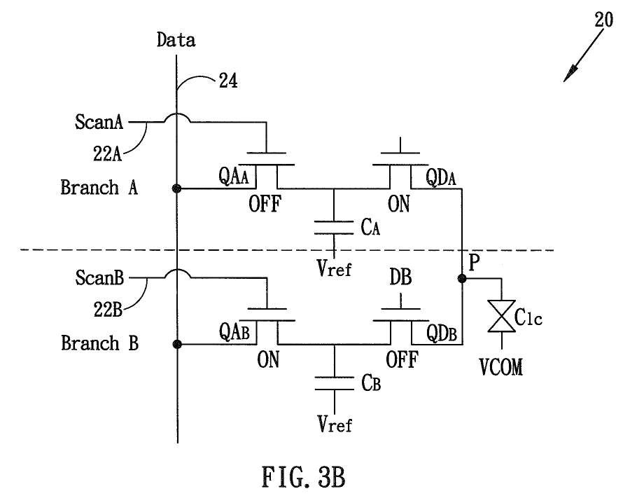

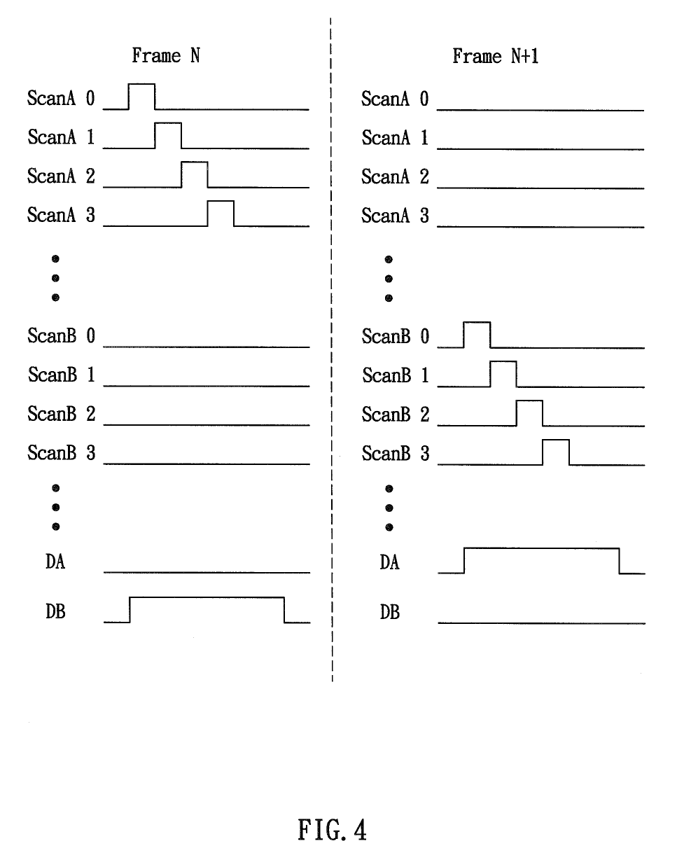

FIG. 3A and FIG. 3B illustrate the operation of the pixel unit cell 20 of FIG. 2B. FIG. 4 shows an exemplary timing diagram illustrating the operation associated with FIG. 3A and FIG. 3B.

In FIG. 3A and Frame N in FIG. 4, Branch A enters an addressing mode, during which the scan signal (ScanA) turns on the addressing transistor QA_{A}, such that the image data (Data) provided along the data line 24 can be stored in the storage capacitor C_{A}. At the same time, the displaying transistor QD_{A} is turned off by the logic-low control signal DA to prevent the stored image data from affecting the other branch (Branch B). The scan driver 220 generates sequential scan signals (ScanA 0, ScanA 1, ScanA 2, etc.) to scan (or address) each row of pixel cells 20 in sequence, for example, from top to bottom.

While Branch A enters the addressing mode, Branch B enters a displaying mode, in which the logic-low scan signal (ScanB 0, ScanB 1, ScanB 2, etc.) turns off the addressing transistor QA_{B}, while the logic-high control signal DB turns on the displaying transistor QD_{B}, such that the image data stored in the storage capacitor C_{B} from the previous frame (not shown) can be displayed.

Subsequently, referring to FIG. 3B and Frame N+1 in FIG. 4, Branch A now enters the displaying mode, in which the logic-low scan signal (ScanA 0, ScanA 1, ScanA 2, etc.) turns off the addressing transistor QA_{A}, while the logic-high control signal DA turns on the displaying transistor QD_{A}, such that the image data stored in the storage capacitor C_{A} from the previous Frame N can be displayed.

While Branch A enters the displaying mode, Branch B enters the addressing mode, during which the scan signal (ScanB) turns on the addressing transistor QA_{B}, such that the image data (Data) provided along the data line 24 can be stored in the storage capacitor C_{B}. At the same time, the displaying transistor QD_{B} is turned off by the logic-low control signal DB to prevent the stored image data from affecting the other branch (Branch A). The scan driver 220 generates sequential scan signals (ScanB 0, ScanB 1, ScanB 2, etc.) to scan (or address) each row of pixel cells 20 in sequence, for example, from top to bottom.

According to the multi-branch pixel structure of the LCoS panel 200 disclosed above, in which the addressing and displaying can be exercised at the same time in different branches respectively, the operating speed thus can be substantially increased.

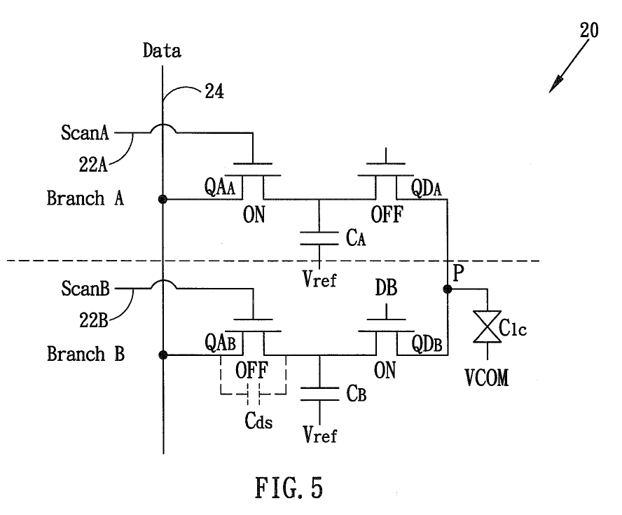

FIG. 5 shows the operation of the pixel unit cell 20 similar to that illustrated in FIG. 3A, with unwanted parasitic capacitance Cds of the addressing transistor QA_{B} having been taken into consideration. The parasitic capacitance Cds unfortunately couples the image data on the data line 24 to the storage capacitor C_{B}, thereby contaminating the stored charge in the storage capacitor C_{B} and thus lowering the display quality.

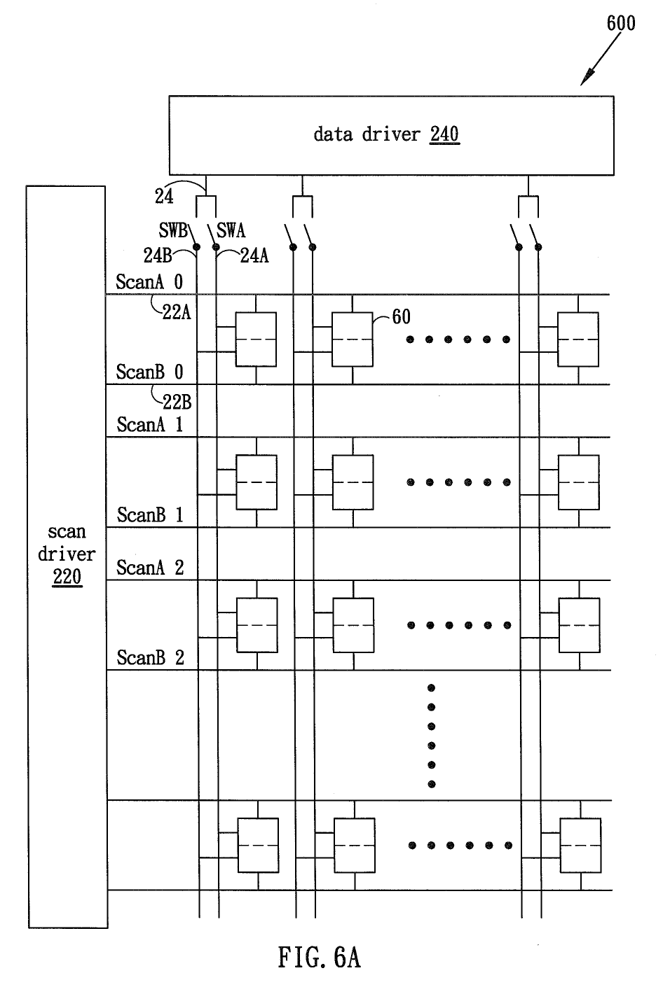

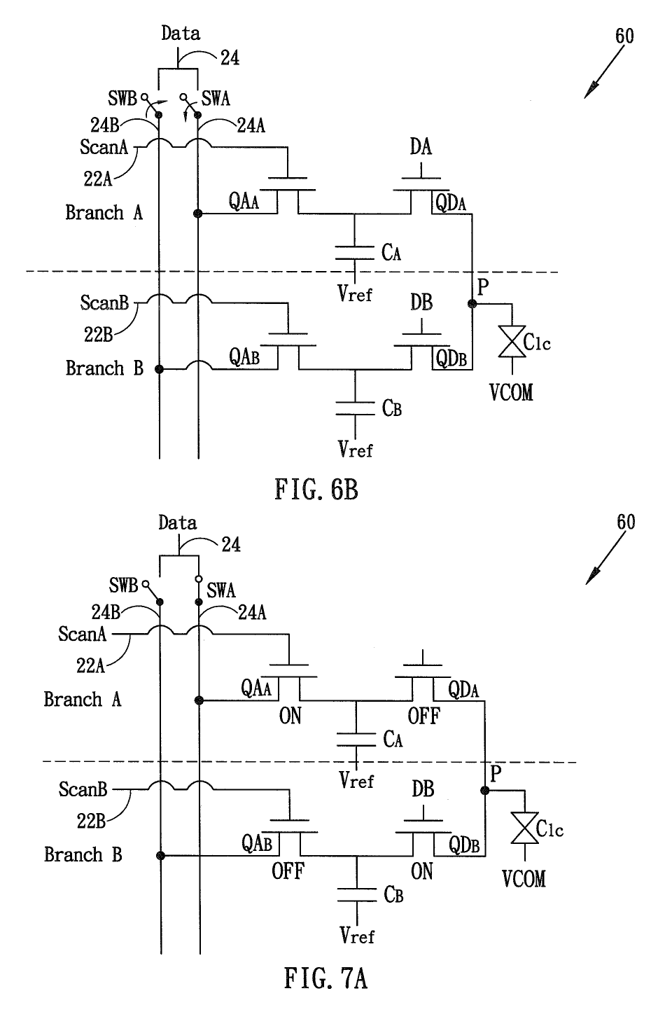

FIG. 6A illustrates a multi-branch pixel structure of the LCoS panel 600 according to one embodiment of the present invention, and FIG. 6B illustrates one of the pixel unit cells 60 of the multi-branch pixel structure in FIG. 6A. The multi-branch pixel structure of the LCoS panel 600 is designed to improve the coupling effect of the LCoS panel 200 mentioned previously, while sustaining its advantage—high operating speed. Components in FIG. 6A and FIG. 6B similar to those in FIG. 2A and FIG. 2B are indicated by use of the same reference numerals or letters. Although the LCoS structure is illustrated here, it is appreciated by those skilled in the pertinent art that the illustrated structure can be well adapted to other flat panel displays, such as LCDs. Referring to FIG. 6A, the LCoS panel 600 includes rows and columns of picture elements (or pixels) or pixel cells 60 arranged in matrix form. Pixel cells 60 in the same row are under control of scan signals (ScanA n and ScanB n, n=0, 1, 2, etc.) through scan lines 22A and 22B; while pixel cells 60 in the same column are electrically coupled to a pair of sub-data lines (24A and 24B). The sub-data lines (24A and 24B) in each pair collectively merge, via a pair of switches (SWA and SWB), into a single data line 24. The scan lines 22A and 22B are controlled by a scan (or gate) driver 220, and the data lines 24 are controlled by a data (or source) driver 240.

Referring to FIG. 6B, the pixel unit cell 60 includes at least two branches, that is, Branch A and Branch B in the embodiment. Taking Branch A as an example, it includes an addressing transistor QA_{A}, which is configured to be addressed, for example, via the gate of the addressing transistor QA_{A}, by a scan signal (ScanA) on the scan line 22A. Specifically, one end, such as the source, of the channel of the addressing transistor QA_{A} is electrically coupled to the data line 24A, which is connected to the sub-data line 24A.

Branch A also includes a storage capacitor C_{A} and a displaying transistor QD_{A}, which have the same configuration as those in FIG. 2B, and their descriptions are thus omitted here for brevity purposes.

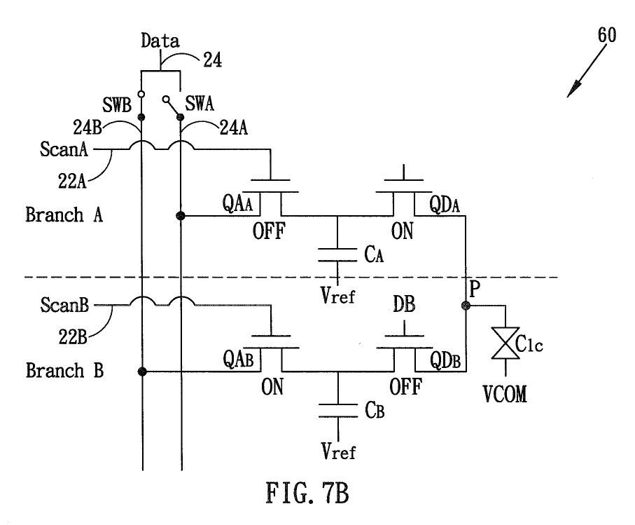

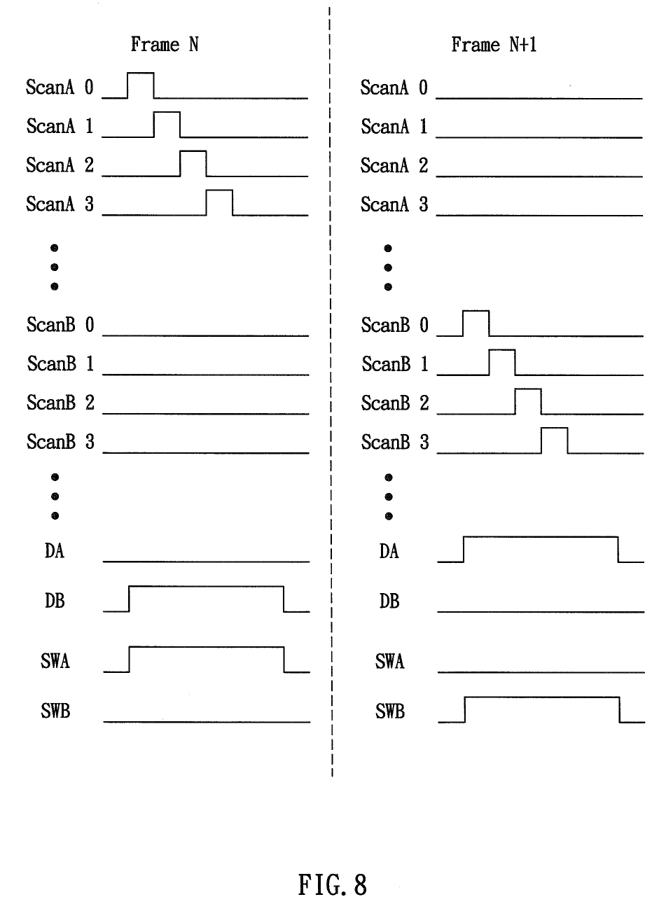

FIG. 7A and FIG. 7B illustrate the operation of the pixel unit cell 60 of FIG. 6B. FIG. 8 shows an exemplary timing diagram illustrating the operation associated with FIG. 7A and FIG. 7B.

In FIG. 7A and Frame N in FIG. 8, Branch A enters an addressing mode, during which the scan signal (ScanA) turns on the addressing transistor QA_{A}, the switch SWA associated with Branch A is closed, and the switch SWB associated with Branch B is open, such that the image data (Data) provided along the data line 24 and the sub-data line 24A can be stored in the storage capacitor C_{A}. At the same time, the displaying transistor QD_{A} is turned off by the logic-low control signal DA to prevent the stored image data from affecting the other branch (Branch B). The scan driver 220 generates sequential scan signals (ScanA 0, ScanA 1, ScanA 2, etc.) to scan (or address) each row of pixel cells 60 in sequence, for example, from top to bottom.

While Branch A enters the addressing mode, Branch B enters a displaying mode in which the logic-low scan signal (ScanB 0, ScanB 1, ScanB 2, etc.) turns off the addressing transistor QA_{B}, while the logic-high control signal DB turns on the displaying transistor QD_{B}, such that the image data stored in the storage capacitor C_{B} from the previous frame (not shown) can be displayed.

Subsequently, referring to FIG. 7B and Frame N+1 in FIG. 8, Branch A now enters the displaying mode, in which the logic-low scan signal (ScanA 0, ScanA 1, ScanA 2, etc.) turns off the addressing transistor QA_{A} while the logic-high control signal DA turns on the displaying transistor QD_{A}. Further, the switch SWA associated with Branch A is open, and the switch SWB associated with Branch B is closed, such that the image data stored in the storage capacitor C_{A} from the previous Frame N can be displayed.

While Branch A enters the displaying mode, Branch B enters the addressing mode, during which the scan signal (ScanB) turns on the addressing transistor QA_{B}, such that the image data (Data) provided along the data line 24 and the sub-data line 24B can be stored in the storage capacitor C_{B}. At the same time, the displaying transistor QD_{B} is turned off by the logic-low control signal DB to prevent the stored image data from affecting the other branch (Branch A). The scan driver 220 generates sequential scan signals (ScanB 0, ScanB 1, ScanB 2, etc.) to scan (or address) each row of pixel cells 60 in sequence, for example, from top to bottom.

According to the multi-branch pixel structure of the LCoS panel 600 disclosed above, in which the addressing and displaying can be exercised at the same time in different branches respectively, the operating speed thus can be substantially increased. Furthermore, as the sub-data lines 24A and 24B are respectively connected to the addressing transistor QA_{A} and the addressing transistor QA_{B}, the data line coupling effect demonstrated in FIG. 5 is thus eliminated, or at least is substantially improved.

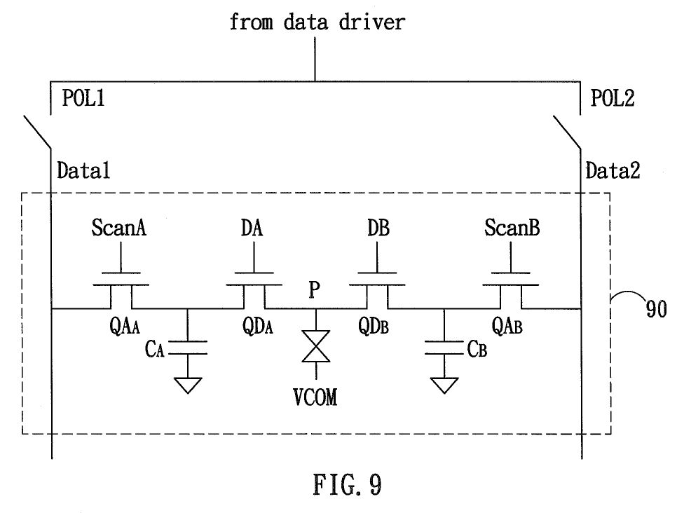

FIG. 9 illustrates one pixel unit cell 90 of a multi-branch pixel structure. The pixel unit cell 90 includes at least two branches: Branch A and Branch B. Branch A includes an addressing transistor QA_{A}, a displaying transistor QD_{A}, and a storage capacitor C_{A}. The addressing transistor QA_{A} is configured to be addressed, for example, via the gate of the addressing transistor QA_{A}, by a scan signal (ScanA) on a Branch-A scan line. Specifically, one end (e.g., the source) of the channel of the addressing transistor QA_{A} is electrically coupled to the Branch-A data line. The storage capacitor C_{A} is configured to receive image data on a data line Data1 via the addressing transistor QA_{A} and a switch POL1. Specifically, the first plate of the storage capacitor C_{A} is electrically coupled to the other end (e.g., the drain) of the channel of the addressing transistor QA_{A}. The second plate of the storage capacitor C_{A} is electrically coupled to the ground or a reference voltage. The stored image data in the storage capacitor C_{A} is displayed through the displaying transistor QD_{A}. The displaying transistor QD_{A} is configured to buffer the stored image data until the startup of the display. Specifically, the gate of the displaying transistor QD_{A} is controlled by a control signal DA. One end (e.g., the source) of the channel of the displaying transistor QD_{A} is electrically coupled to the drain of the addressing transistor QA_{A}, and coupled to the first plate of the storage capacitor C_{A}. Another end (e.g., the drain) of the channel of the displaying transistor QD_{A} is electrically coupled to a pixel electrode P. The description of Branch A applies to the addressing transistor QA_{B}, the storage capacitor C_{B}, the displaying transistor QD_{B}, the scan signal (ScanB), the control signal DB, and the data line Data2 in Branch B. According to the multi-branch pixel structure as disclosed in FIG. 9, each column requires two data lines (that is, Data1 and Data2), which occupy chip area and increase the lateral pixel pitch (or distance between adjacent pixels).

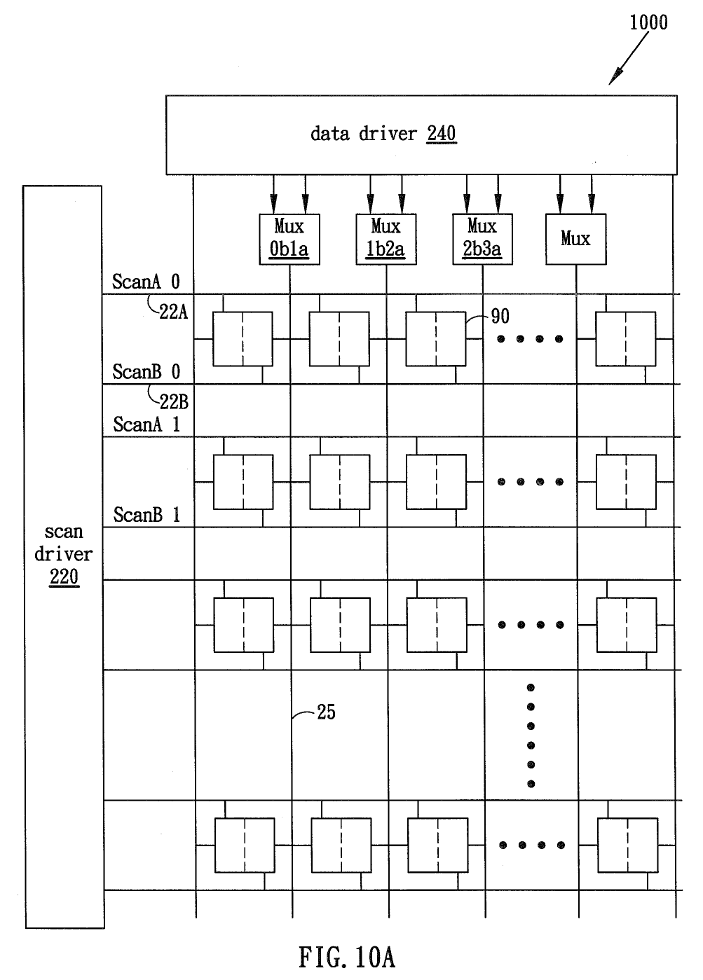

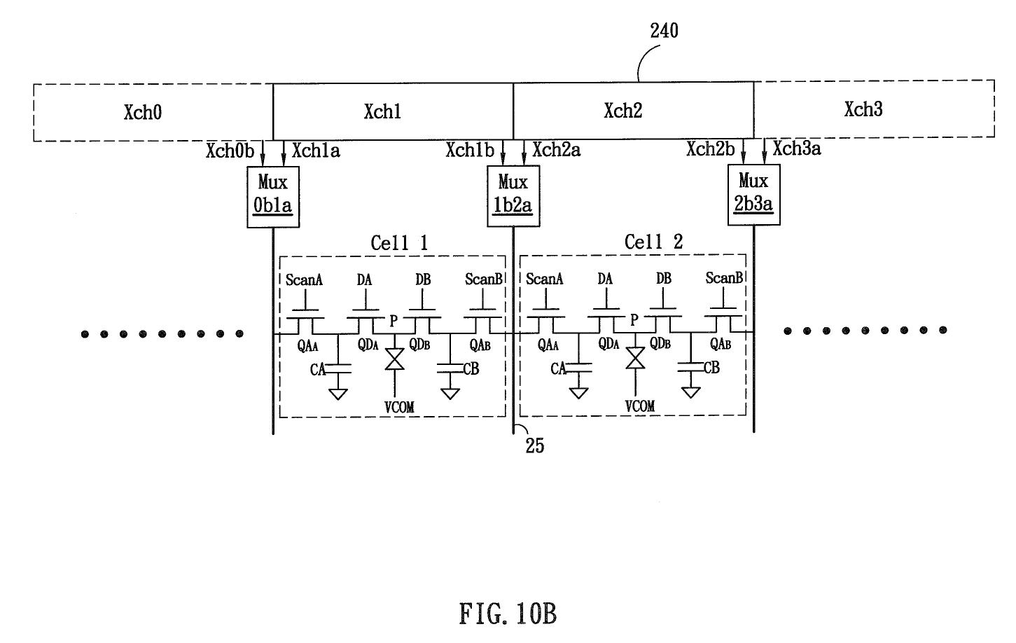

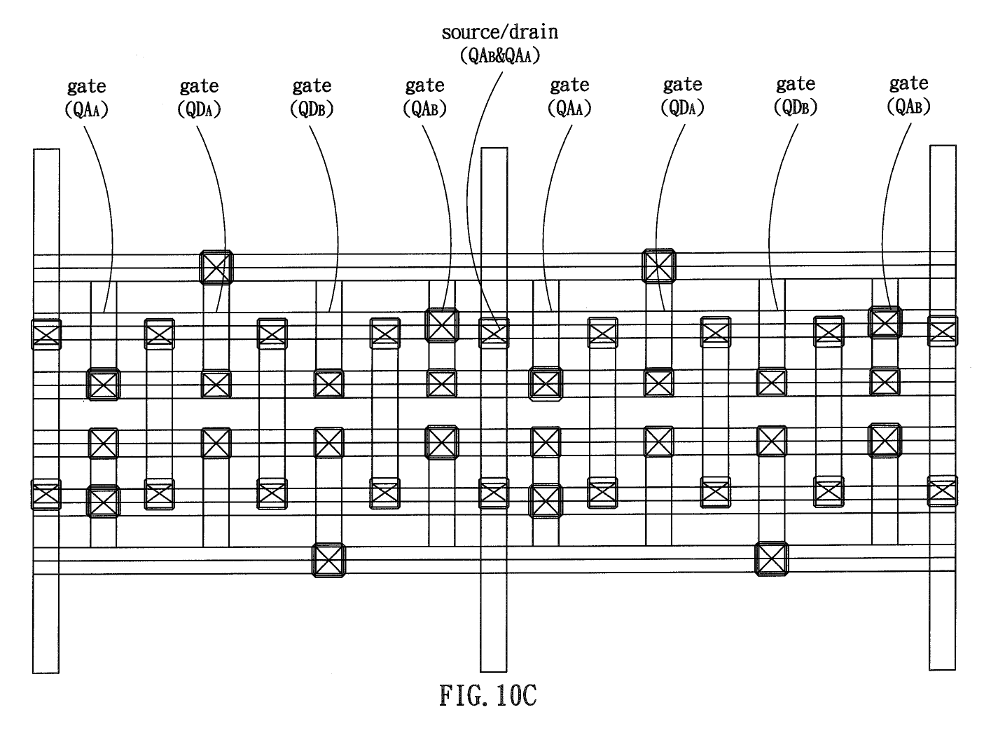

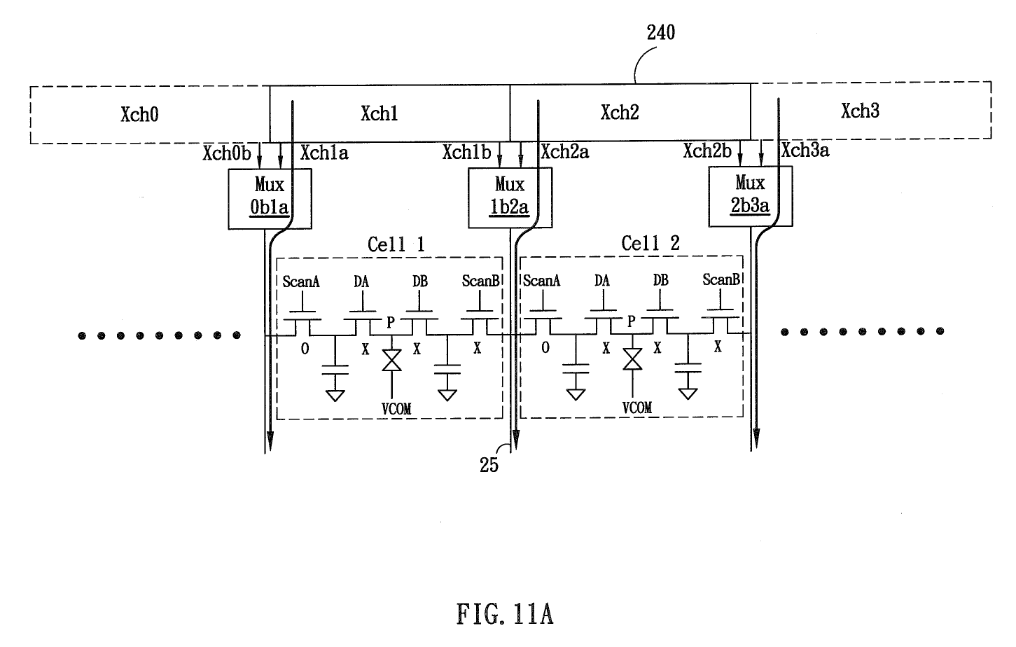

FIG. 10A illustrates a multi-branch pixel structure of the LCoS panel 1000 according to another embodiment of the present invention, and FIG. 10B illustrates detailed circuitry of portions of the multi-branch pixel structure in FIG. 10A. The multi-branch pixel structure of the LCoS panel 1000 is designed to improve on pixel pitch and chip area. Although the LCoS architecture is illustrated here, it is appreciated by those skilled in the pertinent art that the illustrated structure can be well adapted to other flat panel displays, such as LCDs.

Referring to FIG. 10A, the LCoS panel 1000 includes rows and columns of picture elements (or pixels) or pixel cells 90 arranged in matrix form. The pixel cells 90 in the same row are under control of scan signals (ScanA n and ScanB n, n=0, 1, 2, etc.) through scan lines 22A and 22B that are controlled by a scan (or gate) driver 220. Pixel cells 90 in the same column are electrically coupled to a pair of data lines 25, and adjacent pixel cells 90 share the same data line 25 as illustrated in FIG. 10A and FIG. 10B. Specifically, regarding a column Xch1 (FIG. 10B), the data (or source) driver 240 provides two data through a first sub-data line Xch1a and a second sub-data line Xch1b respectively. Likewise, regarding another column Xch2, the data driver 240 provides two data through a first sub-data line Xch2a and a second sub-data line Xch2b respectively. The second sub-data line (e.g., Xch1b) of a column (e.g., the column Xch1) and the first-data line (e.g., Xch2a) of an adjacent column (e.g., the column Xch2) are multiplexed, through a multiplexer Mux (1b2a). The output of the multiplexer Mux (1b2a) is coupled to the data line shared between the adjacent pixel cells (e.g., Cell 1 and Cell 2). The shared data line 25 may be fabricated, for example, by joining the drain of the addressing transistor QA_{B} of Cell 1 and the source of the addressing transistor QA_{A} of Cell 2, as shown in FIG. 10C. In the figure, the schematic layout diagram shows the gates of the transistors in Cell 1 and Cell 2, respectively, and the shared source/drain (i.e., the shared data line). As the adjacent pixel cells share their source/drain, the chip area can be substantially reduced, and the pixel pitch can be substantially reduced laterally.

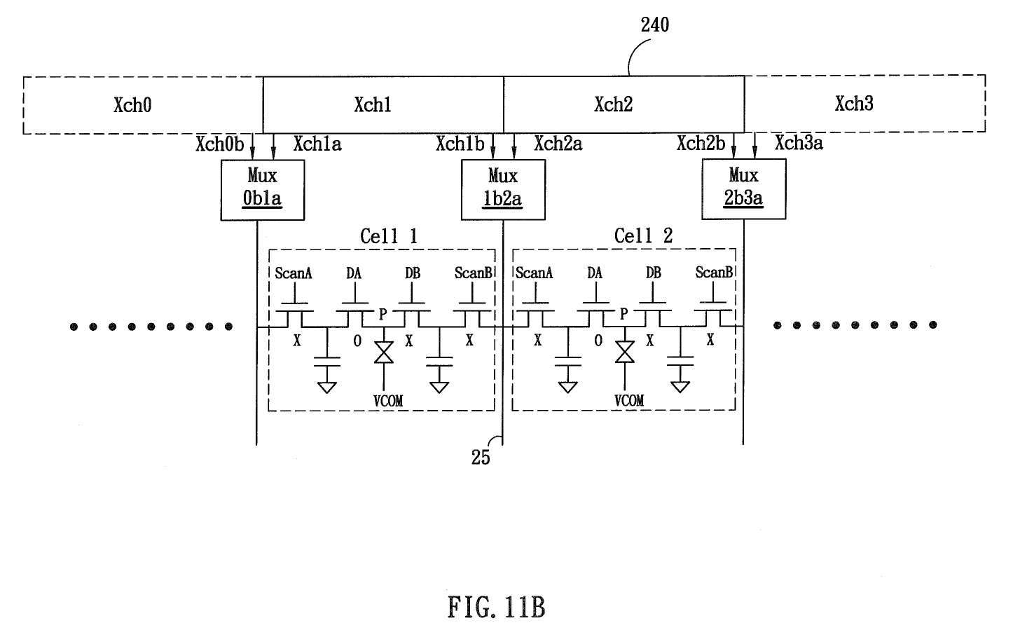

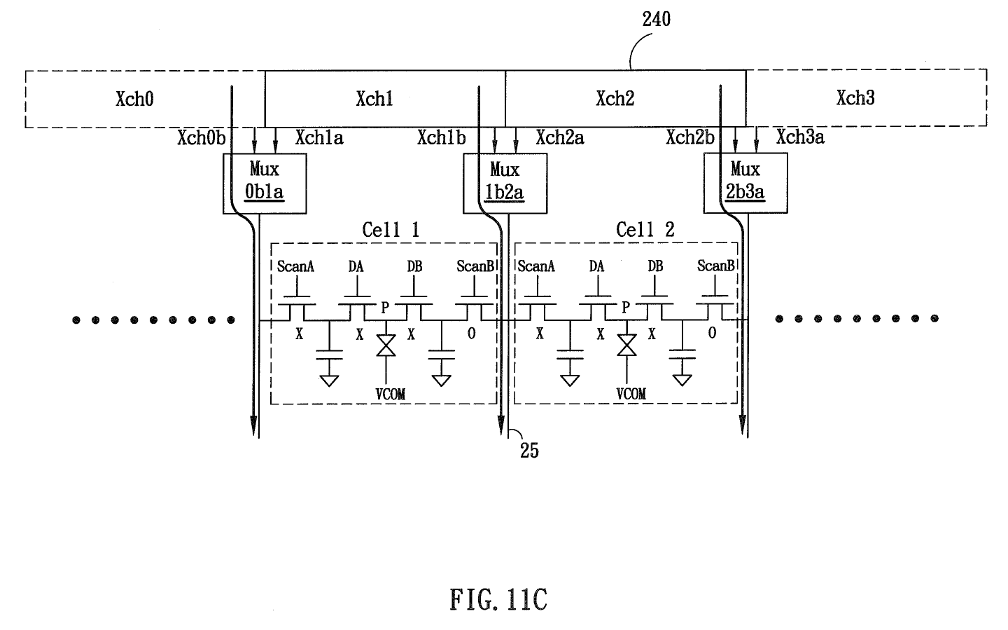

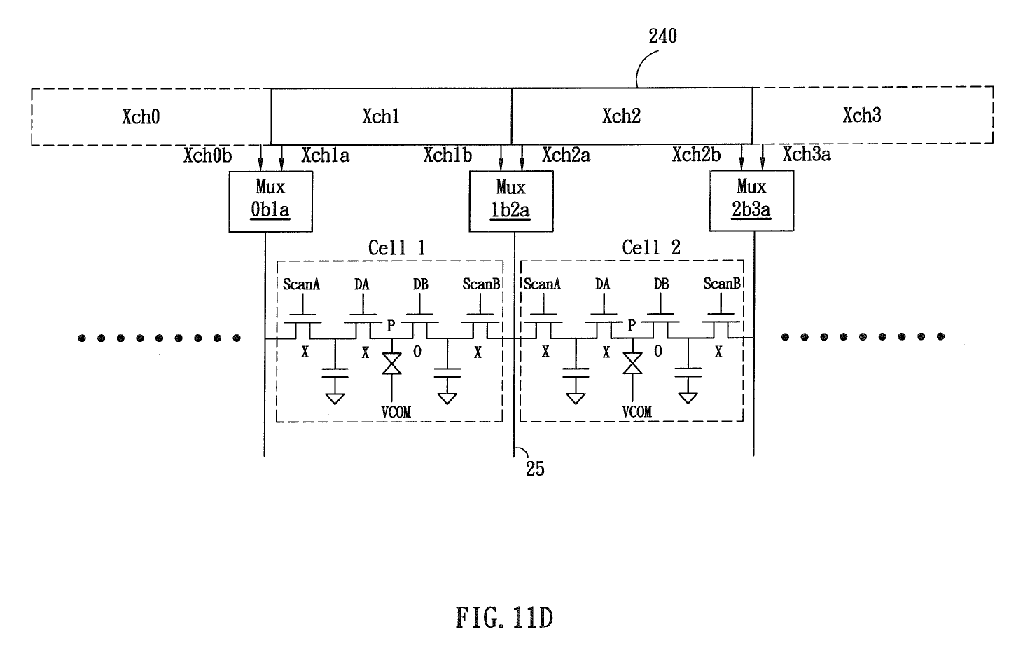

FIG. 11A through FIG. 11D illustrate the operation of the multi-branch pixel structure of the LCoS panel 1000 of FIG. 10A and FIG. 10B. Referring to FIG. 11A, Branch A enters an addressing mode, during which the scan signal (ScanA) turns on the addressing transistor QA_{A}, while other transistors are off. The data on the first (or Branch-A) sub-data line Xchna (n=1, 2, etc.) pass through respective multiplexer Mux, and are then stored on the storage capacitor C_{A} via the addressing transistor QA_{A}. Meanwhile, the data on the second (or Branch-B) sub-data line Xchnb (n=1, 2, etc.) are blocked.

After completion of Branch-A addressing mode for all rows of pixel cells, Branch A enters a displaying mode, as shown in FIG. 11B, during which the control signal DA turns on the displaying transistor QD_{A}, while other transistors are off. Accordingly, the image data stored in the storage capacitor C_{A} of all rows of pixel cells from the previous stage can be displayed.

Subsequently, referring to FIG. 11C, Branch B enters an addressing mode, during which the scan signal (ScanB) turns on the addressing transistor QA_{B}, while other transistors are off. The data on the second (or Branch-B) sub-data line Xchnb (n=1, 2, etc.) pass through respective multiplexer Mux, and are then stored on the storage capacitor C_{B} via the addressing transistor QA_{B}. Meanwhile, the data on the first (or Branch-A) sub-data line Xchna (n=1, 2, etc.) are blocked.

After completion of the Branch-B addressing mode for all rows of pixel cells, Branch B enters a displaying mode, as shown in FIG. 11D, during which the control signal DB turns on the displaying transistor QD_{B}, while other transistors are off. Accordingly, the image data stored in the storage capacitor C_{B} of all rows of pixel cells from the previous stage can be displayed. Although the addressing and displaying modes are operated as illustrated in FIG. 11A through FIG. 11D, it is appreciated that the disclosed multi-branch pixel structure 1000 may operate in other orders.

Although specific embodiments have been illustrated and described, it will be appreciated by those skilled in the art that various modifications may be made without departing from the scope of the present invention, which is intended to be limited solely by the appended claims.

What is claimed is:

1. A system for driving a display panel, comprising:
a plurality of pixel cells arranged in matrix form, each of the pixel cells having at least two branches;
two sub-data lines coupled from a data driver for each column of the pixel cells, wherein the two sub-data lines respectively correspond to the two branches; and
a multiplexer configured to multiplex the sub-data lines between the adjacent pixel cells, such that multiplexed output of the multiplexer is coupled to a shared data line that is shared between the adjacent pixel cells.

2. The system of claim 1, wherein said two branches of the pixel cell are coupled to the shared data lines respectively.

3. The system of claim 1, wherein the display panel is a liquid crystal on silicon (LCoS) panel.

4. The system of claim 1, further comprising at least two scan lines for each row of the pixel cells, wherein the two branches of the pixel cell are associatively coupled to the two scan lines respectively.

5. The system of claim 4, wherein each branch of the pixel cell comprises:
an addressing transistor, configured to be addressed by the associated scan line;
a storage capacitor, configured to receive image data on the associated shared data line and then store the image data therein; and
a displaying transistor, through which the stored image data is displayed.

6. The system of claim 5, wherein:
a gate of the addressing transistor is coupled to the associated scan line;
a first end of channel of the addressing transistor is coupled to the associated shared data line; and
a second end of the channel of the addressing transistor is coupled to one end of the storage capacitor.

7. The system of claim 6, wherein:
a gate of the displaying transistor is coupled to a control signal that starts up a displaying mode;
a first end of channel of the displaying transistor is coupled to the second end of the channel of the addressing transistor; and
a second end of the channel of the displaying transistor is coupled to a pixel electrode.

8. The system of claim 7, wherein the first end of channel of the addressing transistor of a second branch of a first pixel cell is shared with the first end of channel of the addressing transistor of a first branch of a second pixel cell neighboring the first pixel cell.

9. A method of driving a display panel, which has a plurality of pixel cells arranged in matrix form, each of the pixel cells having at least two branches, said method comprising:
multiplexing from one of two sub-data lines coupled to a data driver for one column of the pixel cells, wherein multiplexed output is coupled to a shared data line shared between adjacent pixel cells;
addressing the branch corresponding to the multiplexed sub-data line, such that image data on the multiplexed sub-data line is stored in the addressed branch; and
displaying the stored image data.

10. The method of claim 9, wherein the display panel is a liquid crystal on silicon (LCoS) panel.

11. The method of claim 9, further comprising at least two scan lines for each row of the pixel cells, wherein the two branches of the pixel cell are associatively coupled to the two scan lines respectively.

12. The method of claim 11, wherein each branch of the pixel cell comprises:
an addressing transistor, configured to be addressed by the associated scan line;
a storage capacitor, configured to receive image data on the associated shared data line and then store the image data therein; and
a displaying transistor, through which the stored image data is displayed.

13. The method of claim 12, the addressing step being characterized by the addressing transistor being turned on, while the displaying transistor is turned off.

14. The method of claim 12, the displaying step being characterized by the displaying transistor being turned on and the addressing transistor being turned off.
